(19) United States
(12) Patent Application Publication
(10) Pub. No.: US 2021/0319938 A1
(43) Pub. Date: Oct. 14, 2021

(54) BENT TOROIDAL FIELD COILS

(71) Applicant: Tokamak Energy Ltd, Abingdon Oxfordshire (GB)

(72) Inventors: Marcel Kruip, Abingdon Oxfordshire (GB); Enrique Ruiz de Villa Valdés, Oxford Oxfordshire (GB); Robert Slade, Abingdon Oxfordshire (GB)

(21) Appl. No.: 17/273,636

(22) PCT Filed: Sep. 2, 2019
(86) PCT No.: PCT/GB2019/052442

§ 371 Date: Mar. 4, 2021

(30) Foreign Application Priority Data
Sep. 4, 2018 (GB) 1814351.1

(51) Int. Cl. H01F 7/20; H01F 27/28; H01F 41/04

(52) U.S. Cl. CPC H01F 7/20; H01F 41/04; H01F 27/28

(57) ABSTRACT

A toroidal field coil. The toroidal field coil comprises a central column and a plurality of return limbs. Each return limb comprises a plurality of double pancake, DP, coils, the DP coils comprising high temperature superconducting, HTS, tapes. The DP coils are arranged such that a section of the DP coil which passes through the central column is positioned such that the tapes are aligned substantially with the local magnetic field during operation of the toroidal field coil. At least two DP coils at the outside of each return limb are bent about an axis parallel to the central column such that they each curve inwards towards each other.

### FIELD OF THE INVENTION

The present invention relates to superconducting magnets. In particular, the invention relates to toroidal field coils, e.g. for tokamak fusion reactors.

### BACKGROUND

A superconducting magnet is an electromagnet formed from coils of a superconducting material. As the magnet coils have zero resistance, superconducting magnets can carry high currents with zero loss (though there will be some losses from non-superconducting components), and can therefore reach high fields with lower losses than conventional electromagnets.

Superconductivity only occurs in certain materials, and only at low temperatures. A superconducting material will behave as a superconductor in a region defined by the critical temperature of the superconductor (the highest temperature at which the material is a superconductor in zero applied magnetic field) and the critical field of the superconductor (the highest magnetic field in which the material is a superconductor at 0K). The temperature of the superconductor and the magnetic field present limit the current which can be carried by the superconductor without the superconductor becoming resistive (or “normal”, used herein to mean “not superconducting”). There are two types of superconducting material: type I superconductors totally exclude magnetic flux penetration and have a low critical field, type II allow flux to penetrate the superconductor above the lower critical field within localized normal regions called flux vortices. They cease to be superconducting at the upper critical field. This feature enables them to be used in wires for construction of superconducting magnets. Significant effort is made to pin the flux vortex sites to the atomic lattice, which improves critical current at higher magnetic fields and temperatures.

Superconducting materials are typically divided into “high temperature superconductors” (HTS) and “low temperature superconductors” (LTS). LTS materials, such as Nb and NbTi, are metals or metal alloys whose superconductivity can be described by BCS theory. All low temperature superconductors have a critical temperature (the temperature above which the material cannot be superconducting even in zero magnetic field) below about 30K. The behaviour of HTS material is not described by BCS theory, and such materials may have critical temperatures above about 30K (though it should be noted that it is the physical differences in superconducting operation and composition, rather than the critical temperature, which define HTS material). The most commonly used HTS are “cuprate superconductors”-ceramics based on cuprates (compounds containing a copper oxide group), such as BSCCO (“bismuth strontium calcium copper oxide”), or ReBCO (“rare earth barium copper oxide”, where Re is a rare earth element, commonly Y or Gd). Other HTS materials include iron pnictides (e.g. FeAs and FeSe) and magnesium diborate (MgB₂).

One application of HTS magnets is in tokamak fusion reactors. A tokamak features a combination of strong toroidal magnetic field, high plasma current and, usually, a large plasma volume and significant auxiliary heating, to provide a hot stable plasma so that fusion can occur. The auxiliary heating (for example via tens of megawatts of neutral beam injection of high energy H, D or T) is necessary to increase the temperature to the sufficiently high values required for nuclear fusion to occur, and/or to maintain the plasma current.

To obtain the fusion reactions required for economic power generation (i.e. much more power out than power in), the conventional tokamak has to be huge so that the energy confinement time (which is roughly proportional to plasma volume) can be large enough so that the plasma can be hot enough for thermal fusion to occur.

WO 2013/030554 describes an alternative approach, involving the use of a compact spherical tokamak for use as a neutron source or energy source. The low aspect ratio plasma shape in a spherical tokamak improves the particle confinement time and allows net power generation in a much smaller machine. However, a small diameter central column is a necessity, which presents challenges for design of the plasma confinement magnet.

The primary attraction of HTS for tokamaks is the ability of HTS to carry high currents in intense magnetic fields. This is particularly important in compact spherical tokamaks (STs), in which the flux density on the surface of the centre column will exceed 20 T. A secondary benefit is the ability of HTS to carry high current in high magnetic field at higher temperatures than LTS, for example ˜20 K. This enables use of a thinner neutron shield, resulting in higher neutron heating of the central column, which would preclude operation using liquid helium (ie: at 4.2 K or below). This in turn enables the design of a spherical tokamak with major plasma radius of less than about 2 m, for example about 1.4 m to be considered; such a device would recycle a few percent of its power output for cryogenic cooling.

The low aspect ratio of a Spherical Tokamak (ST) requires the diameter of the core of the plasma chamber to be as small as possible. This in turn will result in necessity for high current densities and high magnetic fields. The high in-field critical current of REBCO superconductors enable very high current densities (>300 A/mm2) to be achieved in the high magnetic fields seen in the core of a compact ST cooled to ˜20 K. Similar performance is not possible with low temperature superconductors such as NbTi and Nb3Sn.

ReBCO is typically manufactured as tapes, with a structure as shown in FIG. 1. Such tape 100 is generally approximately 100 microns thick, and includes a substrate 101 (typically electropolished hastelloy approximately 50 microns thick), on which is deposited by IBAD, magnetron sputtering, or another suitable technique a series of buffer layers known as the buffer stack 102, of approximate thickness 0.2 microns. An epitaxial ReBCO-HTS layer 103 (deposited by MOCVD or another suitable technique) overlays 15 the buffer stack, and is typically 1 micron thick. A 1-2 micron silver layer 104 is deposited on the HTS layer by sputtering or another suitable technique, and a copper stabilizer layer 105 is deposited on the tape by electroplating or another suitable technique, which often completely encapsulates the tape.

The substrate 101 provides a mechanical backbone that can be fed through the manufacturing line and permit growth of subsequent layers. The buffer stack 102 is required to provide a biaxially textured crystalline template upon which to grow the HTS layer, and prevents chemical diffusion of elements from the substrate to the HTS which damage its superconducting properties. The silver layer 104 is required to provide a low resistance interface from the ReBCO to the stabiliser layer, and the stabiliser layer 105 provides an alternative current path in the event that any part of the ReBCO ceases superconducting (enters the “normal” state).

To increase the transport current, and hence reduce coil inductance (and hence inductive voltage during changing transport current), tapes may be stacked to form a cable. In most existing HTS magnet designs, the resulting stack is twisted, or formed into a Roebel-type cable of woven, transposed tapes. However, leaving the stack untwisted increases the current density and mechanical integrity of the stacked tape cable. It also allows the option to align the tapes with the local magnetic field, which maximises the critical current. The lack of twisting and transposition will increase AC coupling loss, but this is not a problem in the toroidal field (TF) magnet as it is not pulsed and can be ramped to field slowly. It will also lead to non-uniform current distribution in the stack, but this also is not considered a problem for tokamak TF coils, since the tapes are small compared with coil size, and the resulting effect on magnetic field homogeneity in the plasma is negligible.

The quench resistance of the TF coils can be increased by creating a “partially insulated” coil, in which the tapes within a turn are all soldered together, for best electrical and thermal conductivity, while the turns are connected by “leaky” insulation. This approach requires a continuous superconducting path around the coil, hence necessitating wound coils rather than other designs such as segments which are later joined to form a coil.

Broadly speaking, there are two types of construction for magnetic coils—by winding, or by assembling several sections. Wound coils are manufactured by wrapping an HTS cable around a former in a continuous spiral. The former is shaped to provide the required inner perimeter of the coil, and may be a structural part of the final wound coil, or may be removed after winding. Sectional coils are composed of several sections each of which may contain several cables or preformed busbars and will form an arc of the overall coil. The sections are connected by joints to form the complete coil.

The simplest type of wound coil is known as a “pancake coil”, where HTS cables are wrapped to form a flat coil, in a similar manner to a spool of ribbon. Pancake coils may be made with an inner perimeter which is any 2 dimensional shape. Often, pancake coils are provided as a “double pancake coil”, which comprises two pancake coils wound in opposite sense, with insulation between the pancake coils, and with the inner terminals connected together. This means that voltage only needs to be supplied to the outer terminals, which are generally more accessible, to drive current through the turns of the coil and generate a magnetic field.

In a spherical tokamak it is desirable to minimize the diameter of the TF centre column, or core, which results in a thicker neutron shield and/or a smaller device. This leads to a requirement to maximize current density in the HTS, which in turn leads to a requirement to align the HTS tapes with the toroidal magnetic field in the core as well as possible.

If the DPs are planar the return limbs would be uniformly arranged on the outside of the tokamak. To maximise packing density of pancakes in the centre column a typical fusion capable ST may need several tens of DPs, this would create a severe problem for access to the plasma. FIG. 2 shows an exemplary toroidal field coil 200 with 48 return limbs 201. Clearly, the space between each return limb at the outside of the TF coil is very restricted, which would prevent easy access to the plasma for instrumentation, RF heating and/or neutral beam injection.

In principle, this could be avoided by a design such as that shown in FIG. 3, where each limb 301 of the TF coil 300 comprises multiple DPs, stacked axially (e.g. 4 DPs in this case, to give 12 return limbs for the same amount of total DPs as in FIG. 1).

FIG. 4 shows a cross section of the central column of the TF coil of FIG. 3, with the magnetic field lines marked. In this configuration, the magnetic field has a clear ripple and the field vector is several degrees misaligned with the plane of the tapes in the outermost pancakes in the stack of DPs going to each limb. This results in significantly reduced critical current in the outer DPs in a stack, so more tape is required to carry the same amount of current in these DPs. Additionally, the force density distribution is unfavourable, and the filling ratio of the available space is low, resulting in a larger diameter to allocate the same amount of tapes. In practice, this is an undesirable approach for a compact ST.

### SUMMARY

According to a first aspect, there is provided a toroidal field coil. The toroidal field coil comprises a central column and a plurality of return limbs. Each return limb comprises a plurality of double pancake, DP, coils, the DP coils comprising high temperature superconducting, HTS, tapes. The DP coils are arranged such that a section of the DP coil which passes through the central column is positioned such that the tapes are aligned substantially with the local magnetic field during operation of the toroidal field coil. At least two DP coils at the outside of each return limb are bent about an axis parallel to the central column such that they each curve inwards towards each other.

According to a second aspect, there is provided a method of manufacturing a toroidal field coil. A plurality of DP coils are manufactured, the plurality of DP coils including DP coils bent about an axis parallel to a central column section of the DP coil. The DP coils are assembled into return limbs, each return limb comprising a plurality of DP coils such that at least two DP coils at the outside of each return limb are bent such that they each curve inwards towards each other. The return limbs are assembled into a toroidal field coil, such that, for each DP coil, a section of the DP coil which passes through the central column is positioned such that the tapes are aligned substantially with the local magnetic field during operation of the toroidal field coil.

### BRIEF DESCRIPTION OF THE DRAWINGS

FIG. 1 is a diagram of a ReBCO tape;

FIG. 2 shows an toroidal field coil;

FIG. 3 shows an alternative toroidal field coil;

FIG. 4 shows a cross section of the central column of the TF coil of FIG. 3;

FIGS. 5A and B show an exemplary TF coil;

FIG. 6 shows a cross section of the central column of the TF coil of FIGS. 5A and B;

FIG. 7 shows a double pancake of the TF coil of FIGS. 5A and B;

FIGS. 8A and B show an alternative exemplary TF coil; and

FIG. 9 shows a double pancake of the TF coil of FIGS. 8A and B

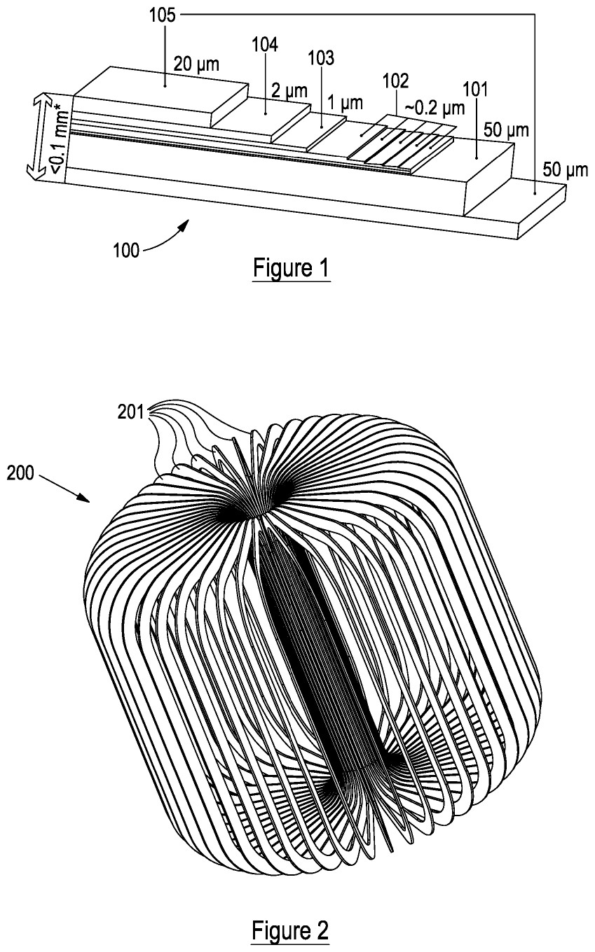

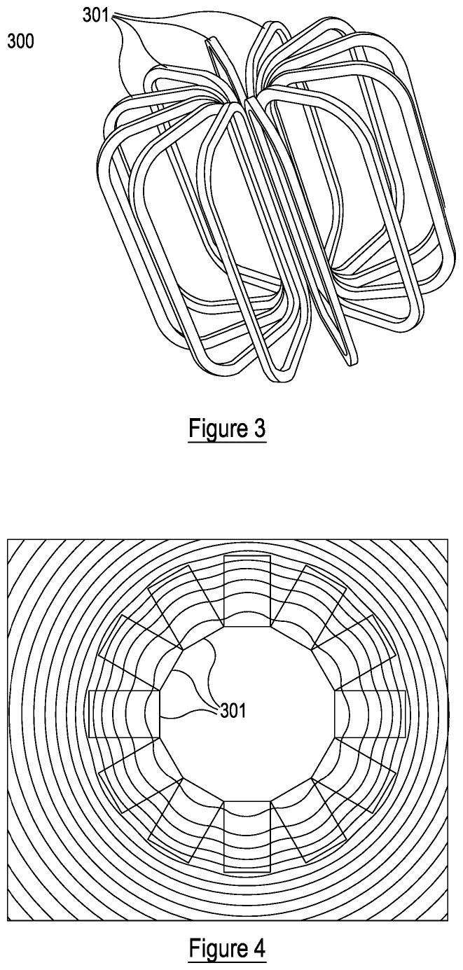

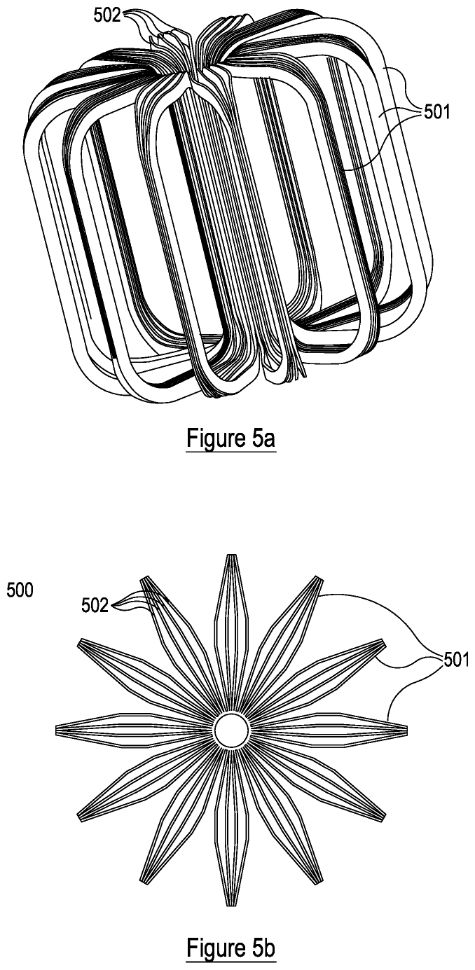

### DETAILED DESCRIPTION

An alternative design of TF coil is proposed below, to allow for both a high level of field uniformity within the central column and easy access to components within the TF coil (e.g. the plasma chamber).

The principle of the alternative design lies in providing double pancake coils (DP) which are curved out of the plane of the coil, such that the tapes of each DP are aligned substantially parallel to the magnetic field at the central column, and the DPs curve away towards the outer radius of the TF coil to increase the space available for access to components within the TF coil.

One example construction is shown in FIG. 5A, and in plan view in FIG. 5B. The TF coil 500 comprises twelve return limbs 501, each comprising four DP coils 502. In the central column, each DP is “field aligned”, i.e. arranged such that the HTS tapes are substantially parallel to the magnetic field. The individual DPs are curved out-of-plane (or “bent”) such that the DPs of each return limb bunch together at the outer radius of the TF coil, so that each return limb forms a “petal shape”, resulting in the “flower-like” top view of FIG. 5B

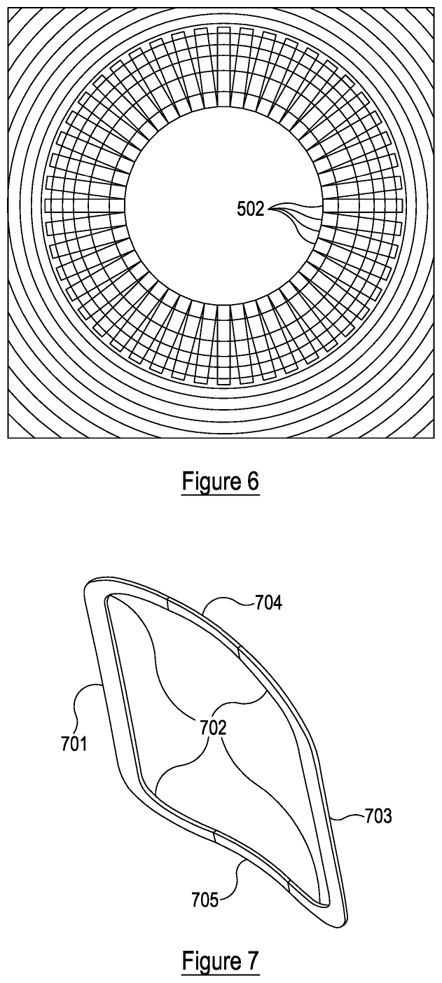

Field lines through the central column section are shown in FIG. 6. Each DP 502 is aligned such that the HTS tapes are substantially parallel to the magnetic field, resulting in higher critical current for the DPs.

An example construction for a DP for use in the example of FIGS. 5A and B is shown in FIG. 7. The DP is shaped as a rounded rectangle, with a central column section 701, four “corner sections” 702, an outer vertical section 703, and two horizontal sections 704, 705 (note that the sections are entirely notional for the sake of description—the DP may be wound continuously, or provided with joints which divide it in other ways). The central column sections, corner sections, and outer vertical sections are structured the same as they would be for a conventional “flat” DP. The horizontal sections 704, 705 each bend through an angle α. α is chosen to provide the required shape for the return limbs, and will be different for DPs at different positions in the respective return limbs.

For example, for a spherical tokamak with 12 return limbs, and a return limb radius of 4 m, a may be 15 degrees (assuming a typical width for the DPs, and as such a typical inner radius for the return limbs at the central column). For a DP wound with 25 mm width tape, this would give a bending strain of 0.21%, which is well within the limit recommended by the manufacturers of some HTS tape (the value of the maximum strain of the HTS tape will vary depending on the tape used).

Such a coil can be wound on a “rocking” winding table, and then bonded by resin impregnation or soldering. Alternatively, the coil may be wound using a rocking taping head (i.e. the spool from which the tape is dispensed may rock, instead of rocking the table). As a further alternative, the coil can be wound as a planar coil, and then subsequently bent and encapsulated with resin or solder. The coil may be enclosed in an external casing or other structural support to ensure that it keeps its shape, and remove any need to “overbend” the coil to compensate for its tendency to straighten out.

A similar construction can be used toroidal field magnets with “D-shaped” DP coils, i.e. without a horizontal section, or other shapes of DP coils, where the bend occurs over a significant portion, e.g. at least 10%, of the length of the DP coil outside of the central column.

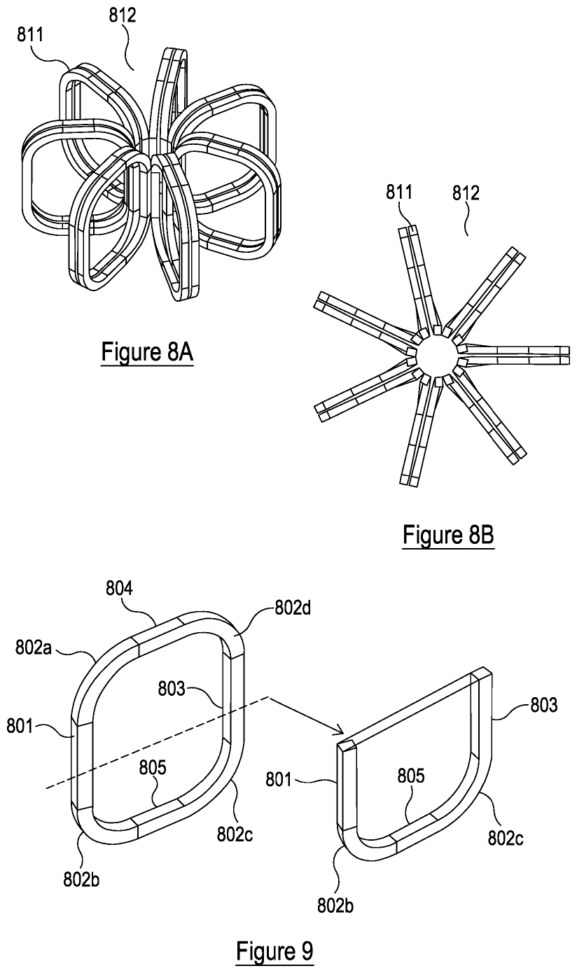

An alternative construction is shown in FIGS. 8A (isometric view) and B (equatorial cross section) and FIG. 9 (single coil). Each DP is shaped as a rounded rectangle with a central column section 801, four “corner sections” 802a-d, an outer vertical section 803, and two horizontal sections 804, 805 (note that the sections are entirely notional for the sake of description—the DP is wound continuously). The horizontal sections 804, 805, outer corner sections 802c, 802d, and outer vertical section 803 are structured the same as they would be for a conventional “flat” DP. The inner corner sections 802a, 802b are structured such that the central column section 801 is rotated around a vertical axis compared to its orientation in a “flat” DP, i.e. the inner corner sections have both a 90° bend about a horizontal axis and a twist about the vertical axis.

When assembled into a full TF coil, the central column section 801 of each DP is aligned with the HTS tapes perpendicular to the radius of the central column, and the DPs are arranged in return limbs 811 (e.g. pairs as shown in FIGS. 8A and 9B) so as to leave gaps 812 where the DPs on either side of the gap bend away from the gap.

In a further example, the DPs of FIG. 9 may be arranged with three DPs to each return limb, with the outer DPs of the return limb being DPs as shown in FIG. 9 (one being a reflection of the other), and the central DP being a flat DP.

1. A toroidal field magnet comprising a central column and a plurality of return limbs, wherein:
each return limb comprises a plurality of double pancake, DP, coils, the DP coils comprising high temperature superconducting, HTS, tapes;
the DP coils are arranged such that a section of the DP coil which passes through the central column is positioned such that the tapes are aligned substantially with the local magnetic field during operation of the toroidal field coil;
at least two DP coils at the outside of each return limb are bent about an axis parallel to the central column such that they each curve inwards towards each other.

2. The toroidal field magnet according to claim 1, wherein a central DP coil of each return limb is planar.

3. The toroidal field magnet according to claim 1, wherein each DP coil that is bent is bent over a section of the DP coil extending at least 10% of the length of the DP coil outside of the central column.

4. The toroidal field magnet according to claim 1, wherein each DP coil that is bent is bent in a horizontal section of the DP coil.

5. The toroidal field magnet according to claim 1, wherein each DP coil that is bent is bent in a curved section of the DP coil adjacent to the central column.

6. A method of manufacturing a toroidal field magnet, the method comprising:
manufacturing a plurality of DP coils, the plurality of DP coils including DP coils bent about an axis parallel to a central column section of the DP coil;
assembling the DP coils into return limbs, each return limb comprising a plurality of DP coils such that at least two DP coils at the outside of each return limb are bent such that they each curve inwards towards each other
assembling the return limbs into a toroidal field coil, such that, for each DP coil, a section of the DP coil which passes through the central column is positioned such that the tapes are aligned substantially with the local magnetic field during operation of the toroidal field coil.

7. The method according to claim 6, wherein manufacturing the plurality of DP coils comprises, for each bent DP coils, winding the DP coil as planar and subsequently bending the DP coil out-of-plane.

8. The method according to claim 6, wherein manufacturing the plurality of DP coils comprises, for each bent DP coil, winding the DP coil on a former shaped to provide the required bend.

9. The method according to claim 8, wherein the former is a rocking winding table.

10. The method according to claim 6, wherein manufacturing the plurality of DP coils comprises, for each bent DP coil, winding the DP coil with a rocking taping head.

11. The method according to any of claim 6, and comprising one or both of:
impregnating each bent DP coil with epoxy resin, solder or other suitable bonding agent;
enclosing each bent DP coil in a casing.
